(19) United States
(12) Patent Application Publication
(10) Pub. No.: US 2012/0288316 A1
(43) Pub. Date: Nov. 15, 2012

(54) PRINTER

(75) Inventor: YI-KUN CHEN, Tu-Cheng (TW)

(73) Assignee: HON HAI PRECISION INDUSTRY CO., LTD., Tu-Cheng (TW)

(21) Appl. No.: 13/163,746

(22) Filed: Jun. 20, 2011

(30) Foreign Application Priority Data
May 12, 2011 (TW) 100116751

(51) Int. Cl. B41J 11/04

(52) U.S. Cl. 400/611

(57) ABSTRACT

A printer having an ink drying apparatus is provided. The printer includes a hollow metal cylinder; a heater, disposed in an inner surface and along axial direction of the hollow metal cylinder; a print assembly; a feed roller, to feed a print media towards the print assembly; a support substrate, for supporting the print media, an idle gear, connected with the feed roller assembly and the hollow metal cylinder. The feed roller assembly rolls the idle gear, thereby drives the hollow metal cylinder to roll at same rate as the feed roller assembly and the idle gear. A printing method is also provided.

### CROSS-REFERENCE TO RELATED APPLICATIONS

Related subject matter is disclosed in a copending application entitled, “PRINTER”, filed on **** (Application No. *****, Atty. Docket No. U.S. 38892), and assigned to the same assignee as named herein.

### BACKGROUND

1. Technical Field

The present disclosure relates to printers, and more particularly to a printer having an ink drying apparatus which can effectively dry ink on a print media thereof.

2. Description of Related Art

FIG. 1 is a sectional view schematically showing a conventional printer. In FIG. 1, a conventional printer 100 includes a heater 10, a heat substrate 20, a print assembly 30, a feed roller assembly 40, and a print media 50. The heater 10 may be a halogen lamp. The print media 50 may be a paper. The heat substrate 20 is set above the heater 10, for transmitting heat generated by the heater 100 to the print media 50. The print assembly 30 includes a print head, for spraying ink on the print media 50 to form an image. The feed roller assembly 40 feeds the print media 50 towards the print assembly 30 along the heat substrate 20. The print media 50 is dried after the ink is sprayed and output after being printed, thereby the print media 50 is prevented from being wet and distorted.

However, employing the heat substrate 20 to dry the print media 50 leads to high heat loss, increases overall size of the printer, and the print media 50 cannot absorb heat uniformly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a sectional view schematically showing a conventional printer.

FIG. 2 is a sectional view schematically showing a printer employing an ink drying apparatus according to an embodiment of the present disclosure.

FIG. 3 is a flowchart of one embodiment of a printing method of the printer of FIG. 2 in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

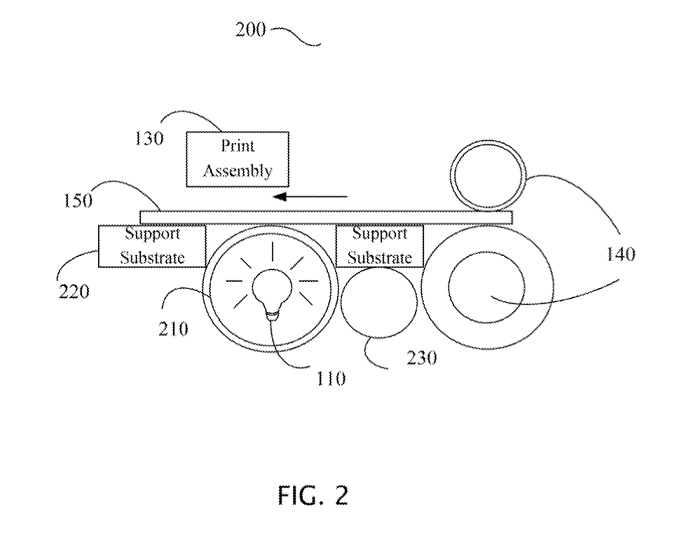

FIG. 2 is a sectional view schematically showing a printer employing an ink drying apparatus according to an embodiment of the present disclosure.

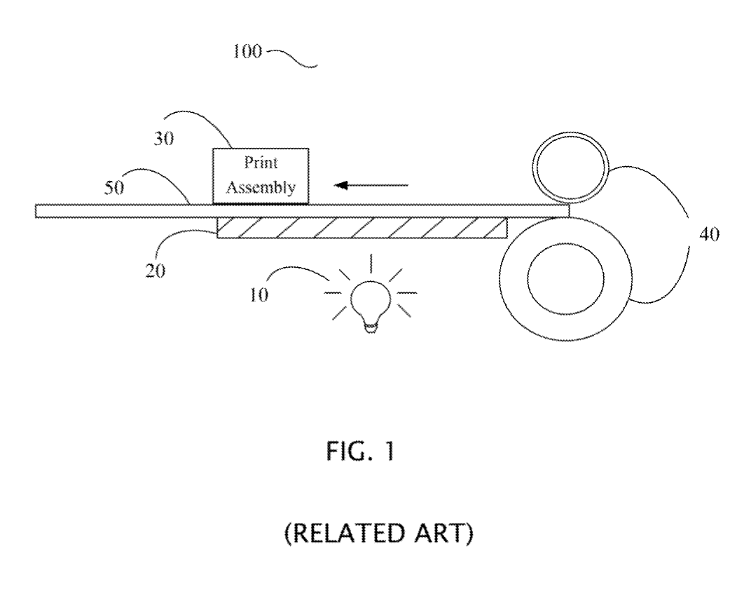

Different from FIG. 1, the printer 200 further includes a hollow metal cylinder 210, a support substrate 220, and an idle gear 230.

A heater 110 is disposed in the inner surface and along the axial direction of the hollow metal cylinder 210. The hollow metal cylinder 210 is formed of material, which has a high heat-conductivity, such as aluminum. However, the hollow metal cylinder 210 can be formed of any suitable conductive material.

The support substrate 220 is set into two parts, separately installed on two sides of the hollow metal cylinder 210 and below a print assembly 130, for supporting the print media 150.

The idle gear 230 is connected with a feed roller assembly 140 and the hollow metal cylinder 210 by rolling. The axises of the hollow metal cylinder 210, the idle gear 230, and the feed roller assembly 140 are parallel. The idle gear 230 is rolled by the feed roller assembly 140, and thereby drives the hollow metal cylinder 210 to roll at same rate as the feed roller assembly 140 and the idle gear 230.

When transmitted between the print assembly 130 and the support substrate 220, a print media 150 is dried after the ink is sprayed by the hollow metal cylinder 210. As the print media 150 is dried when the hollow metal cylinder 210 rolls, thereby heat loss is decreased, and the print media 150 absorbs uniform heat.

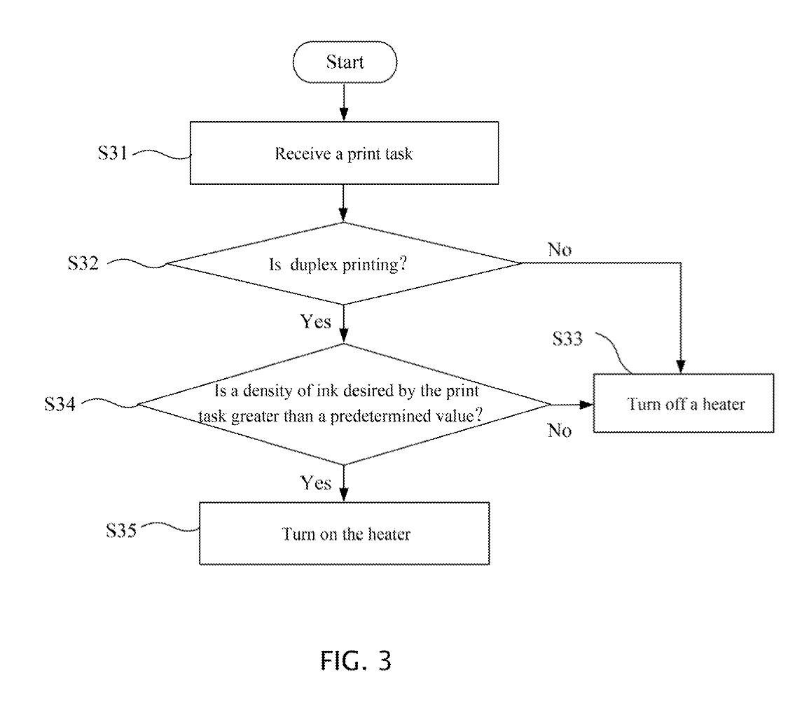

FIG. 3 is a flowchart of one embodiment of a printing method of the printer of FIG. 2 in accordance with the present disclosure.

In step S31, the printer 200 receives a print task.

In step S32, the printer 200 determines if the print task is duplex printing, if yes, the procedure goes to step S34, if no, the procedure goes to step S33.

In step S33, the printer 200 turns off the heater 110 in the hollow metal cylinder 210.

In step S34, the printer 200 determines if a density of ink desired by the print task is greater than a predetermined value. If yes, the procedure goes to step S35, if no, the procedure jumps back to step S33.

In step S35, the printer 200 turns on the heater 110 in the hollow metal cylinder 210.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A printer comprising:
a hollow metal cylinder;
a heater, disposed in an inner surface and along axial direction of the hollow metal cylinder;
a print assembly;
a feed roller, to feed a print media towards the print assembly;
a support substrate, for supporting the print media; and
an idle gear, connected with the feed roller assembly and the hollow metal cylinder by rolling,
wherein the idle gear is rolled by the feed roller assembly, and thereby drives the hollow metal cylinder to roll at same rate as the feed roller assembly and the idle gear.

2. The printer as claimed in claim 1, wherein axises of the hollow metal cylinder, the idle gear and the feed roller assembly are parallel.

3. The printer as claimed in claim 1, wherein the support substrate is set into two parts, separately installed on two sides of the hollow metal cylinder and below the print assembly.

4. The printer as claimed in claim 1, wherein the hollow metal cylinder is formed of material which has a high heat-conductivity.

5. A printing method comprising:
supplying a printer comprising a hollow metal cylinder; a heater, disposed in an inner surface and along axial direction of the hollow metal cylinder; a print assembly; a feed roller, to feed a print media towards the print assembly; a support substrate, for supporting the print media; an idle gear, connected with the feed roller assembly and the hollow metal cylinder by rolling, wherein the idle gear is rolled by the feed roller assembly, and thereby drives the hollow metal cylinder rolling at same rate as the feed roller assembly and the idle gear;
receiving a print task;
determining if the print task is duplex printing;
determining if a density of ink desired by the print task is greater than a predetermined value when the print task is duplex printing;
turning off the heater in the hollow metal cylinder when the print task is not duplex printing or the density of ink desired by the print task is not greater than the predetermined; and
turning on the heater in the hollow metal cylinder when the print task is duplex printing and the density of ink desired by the print task is greater than the predetermined value.

6. The printing method as claimed in claim 5, wherein axises of the hollow metal cylinder, the idle gear and the feed roller assembly are parallel.

7. The printing method as claimed in claim 5, wherein the support substrate is set into two parts, separately installed on two sides of the hollow metal cylinder and below the print assembly.

8. The printing method as claimed in claim 5, wherein the hollow metal cylinder is formed of material which has a high heat-conductivity.
